(19) United States
(12) Patent Application Publication
(10) Pub. No.: US 2013/0282559 A1
(43) Pub. Date: Oct. 24, 2013

(54) SYSTEMS AND METHODS FOR FACILITATING COMMERCIAL TRANSACTIONS UTILIZING A SYSTEM CURRENCY

(71) Applicant: Steve Pappas, New York, NY (US)

(72) Inventor: Steve Pappas, New York, NY (US)

(21) Appl. No.: 13/449,784

(22) Filed: Apr. 18, 2012

(51) Int. Cl. G06Q 20/22

(52) U.S. Cl. 705/39

(57) ABSTRACT

Disclosed herein are systems and methods for facilitating commercial transactions between a plurality of associated parties utilizing a form of currency referred to herein as “system currency” which provides economic utility to all associated parties. The associated parties conducting commercial transactions may include one or more consumers, one or more vendors and one or more banks. The systems and methods for facilitation of commercial transactions may be embodied in a transaction facilitation system, which may comprise a computer network, a human-operated network, or another form of organization or network capable of providing the required functionality. A system transaction facilitator may be present for operating the transaction facilitation system.

### TECHNICAL FIELD

This disclosure is directed to systems and methods for facilitating commercial transactions using a system currency, and more particularly, to systems and methods for providing monetary benefits to consumers, vendors and banks by facilitating commercial transactions driven by the system currency.

### BACKGROUND

There exists a need in the marketplace for a system that allows consumers, vendors and financial institutions to efficiently exchange goods and services in a unified manner wherein the economic interests of all parties are in alignment. As used herein, the term “financial institutions” refers to any type of financial institution including, without limitation, commercial banks, investment banks, credit unions, savings and loans, or new types of financial institutions, all of which will be referred to herein for simplicity as a “bank” or “banks”.

Vendors (any person or entity that provides goods and/or services) that are driven by consumer purchases are constantly working to increase revenues and profit by drawing in new customers, increasing sales and reducing costs. Vendors also require cash for operating expenses, and may seek loans from banks to satisfy such need. Consumers (any person or entity that purchases goods or services from a vendor) generally require banks for holding cash and managing financial transactions, and also have a desire to increase their buying power by purchasing goods or services at discounted prices.

Many techniques are used in the retail industry to increase sales. Preferably, such techniques are designed with the aim of generating new “repeat customers.” Repeat consumers, due to factors such as brand loyalty or reputation, or for other reasons, tend to prefer one brand over another. Vendors may drive an increase in repeat customers through a wide variety of methods, such as advertising campaigns, recognizable product design, and by providing monetary incentives in the form of discounts to consumers who are repeat purchasers of certain brands of goods or services.

For example, coupons are routinely provided for certain goods or services or for certain brands, with the intention of building brand loyalty. Coupons are distributed through magazines, newspapers, online, or through other means. When a consumer wishes to make a purchase using the coupon, the consumer brings the coupon to a retail store offering the goods or services for sale, provides the coupon, pays the discounted price indicated and receives the indicated goods or services.

Coupon use has several undesirable drawbacks. Coupons may fail to drive the desired brand loyalty from consumers who scour publications simply looking for coupons offering the lowest prices. Consumers may also misplace coupons they have found, and/or may simply forget certain coupons, in which case the consumer will not be incentivized towards purchasing goods or services from a specific vendor.

Another method of driving customer loyalty includes providing a consumer discount account which stores a number of consumer discount points with which consumers may purchase goods or services at discounted prices, based on a number of accumulated points. For example, consumers may acquire points by purchasing goods or services from a specific vendor, and may use such acquired points to purchase discounted goods or services from the same vendor. Therefore, such points reward a consumer for loyalty to the vendor's goods and services.

However, several drawbacks exist for such systems. A consumer must save up a specific required number of points for any desired discounted purchase. Therefore, for points programs to be useful, a consumer must have a reason to accumulate a specific number of points with a particular vendor. A consumer may purchase only a small number of goods or services from vendors participating in a points program, and may not accumulate a useful number of points. In this situation, despite having already made several purchases of a specific vendor's goods or services, the consumer may still not feel sufficiently incentivized to continue purchasing goods or services from that vendor.

A drawback of offering discounts is that the interests of vendors and consumers are not always aligned. For example, vendors may discount unpopular items for reasons that are not in alignment with consumer interests. Such reasons may include a desire to dispose of old and unpopular inventory. In these situations, if a consumer wishes to purchase goods or services at a discount, the consumer will not necessarily receive a discount on goods or services that they desire.

In addition to the need to increase sales volume, vendors often need cash for daily operating expenses such as payroll, purchasing raw materials, and other expenses. Often, due to temporary fluctuations in cash intake, even vendors that are otherwise profitable over the course of the year require loans. Interest rates charged by banks for loans may be based on a wide variety of factors, including loan duration, the availability of collateral, the purpose of the loan, the credit rating of the borrower, and many other factors. Interest payments represent a necessary but undesirable additional operating expense. It is desirable for vendors to reduce loan interest expenses.

### SUMMARY

These and other purposes are achieved by providing systems and methods for facilitating commercial transactions between a plurality of associated parties utilizing a form of currency referred to herein as “system currency” which provides economic utility to all associated parties. The associated parties conducting commercial transactions may include one or more consumers, one or more vendors and one or more banks.

The systems and methods for facilitation of commercial transactions may be embodied in a transaction facilitation system, which may comprise a computer network, a human-operated network, or another form of organization or network capable of providing the required functionality. A system transaction facilitator may be present for operating the transaction facilitation system.

The system currency is utilized to confer certain economic rights or benefits on any participating member of the system who holds system currency.

For example, system currency allows consumers to purchase goods and services from vendors associated with the system using a combination of cash and system currency, or using only system currency, resulting in consumers obtaining goods and services at reduced cash prices. Such reduced cash prices are sometimes referred to herein as “discounted” prices, with the understanding that the term “discount” in this context contemplates a reduced cash price, to be accompanied by or replaced entirely with system currency. Additionally, vendors may utilize system currency to obtain business loans at a favorable interest rate from banks associated with the system. Vendors may also act as consumers, and may utilize system currency in combination with cash to purchase goods and services from other vendors associated with the system at reduced cash prices. The system currency may also be traded through the system in a variety of prescribed transactions or may be redeemed for cash.

The transactions conducted through the use of the system, such as purchasing goods or services or obtaining loans, are transactions normally conducted by consumers or vendors in their day-to-day business. However, by providing incentives in the form of monetary benefits for conducting these transactions throughout the disclosed system, the system is designed to drive an increase in the overall number of such transactions that are completed. For example, the reduced cash prices provided for consumers purchasing goods or services preferably lead to consumers purchasing additional goods or services. This increase in the overall number of such transactions represents a total increase in the amount of economic activity for the parties involved. It is anticipated that if the system were used in a widespread manner, it may have the capability of generating a substantial boost in a local, national or international economy.

Further, associated parties are incentivized to continue utilizing the system. The fact that at any time after transactions have been conducted, parties may have balances of unspent quantities of system currency encourages parties to return to use the system in order to spend, redeem, or otherwise utilize this unspent system currency.

An overall result of the system is that by encouraging increased consumer spending, the system facilitates “investment” by consumers into the businesses of vendors. The system also permits vendors to reduce costs by utilizing the sales infrastructure provided by the system, obtain free advertising through exposure to consumers who might not otherwise have knowledge of the vendor, and obtain loans at favorable interest rates. All of these vendor benefits are the result of additional consumer spending, which is the result of reduced cash prices encouraged by the system. The system thereby aligns the interests of each of the parties.

In accordance with these and other goals, a system for facilitating commercial transactions is provided. The system comprises a facilitator component adapted to monitor a consumer special account associated with the system for storing system currency for a consumer, and a vendor special account associated with the system for storing system currency for a vendor; and facilitate transactions utilizing system currency, the transactions being one or more of: a first transaction in which the consumer deposits cash in the consumer special account and receives a first amount of system currency into the consumer special account; a second transaction in which the consumer purchases goods and/or services at reduced cash prices from the vendor, and at least a portion of the system currency in the consumer special account is transferred to the vendor special account; and a third transaction in which at least a portion of the system currency in the vendor special account is withdrawn from the vendor special account and used to obtain goods and/or services from another party associated with the system.

A method of facilitating commercial transactions is also provided. The method comprises: monitoring a consumer special account for storing system currency for a consumer, and a vendor special account for storing system currency for a vendor; facilitating a first transaction in which the consumer deposits cash into the consumer special account and receives a first amount of system currency into the consumer special account; facilitating a second transaction the consumer purchases goods and/or services at a reduced cash price from the vendor, and at least a portion of the system currency in the consumer special account is transferred to the vendor special account; and facilitating a third transaction between the vendor and the bank in which at least a portion of the system currency in the vendor special account is withdrawn from the vendor special account and used to obtain goods and/or services from another party associated with the system.

Other objects, features and advantages will be apparent when the detailed description of the preferred embodiments is considered in conjunction with the drawings.

### BRIEF DESCRIPTION OF THE DRAWINGS

FIG. 1A is a block diagram depicting several transactions that involve system currency, conducted utilizing a first embodiment of a system, in which the bank and the system transaction facilitator are separate entities.

FIG. 1B is a block diagram depicting several transactions that involve system currency, conducted utilizing a second embodiment of a system, in which the bank and the system transaction facilitator are the same entities.

FIG. 2A is a block diagram depicting a first example embodiment of a system.

FIG. 2B is a block diagram depicting a second example embodiment of a system.

FIG. 3A depicts an exemplary screenshot showing the functionality of a consumer component of a system in banking mode.

FIG. 3B depicts an exemplary screenshot showing the functionality of a consumer component of a system in purchase mode, in which a consumer can view fixed-price offerings of goods and services.

FIG. 3C depicts an exemplary screenshot showing the functionality of a consumer component of a system in purchase mode, in which a consumer can view auction-format offerings of goods and services.

FIG. 4A depicts an exemplary screenshot showing the functionality of a vendor component of a system in banking mode, in which a vendor can make a request for a loan at a favorable interest rate and can redeem system currency for cash.

FIG. 4B depicts an exemplary screenshot showing the functionality of a vendor component of a system in banking mode, in which a vendor can manage outstanding loans.

FIG. 4C depicts an exemplary screenshot showing the functionality of a vendor component of a system in price setup mode, in which a vendor can manually enter desired reduced cash prices for goods and/or services or choose to offer goods and/or services for sale in an auction format.

FIG. 4D depicts an exemplary screenshot showing the functionality of a vendor component of a system in price setup mode, in which a vendor can choose from among a set of recommended reduced cash prices for their goods and/or services.

FIG. 4E depicts an exemplary screenshot showing the functionality of a vendor component of a system in price setup mode, in which a vendor can communicate with a system transaction facilitator or system operating bank to determine a desired reduced cash price to offer for goods and/or services.

FIG. 5A depicts an exemplary screenshot showing the functionality of a bank component of a system in consumer mode, in which a bank can view deposits recently made by consumers and can view the number of units of system currency distributed to those consumers.

FIG. 5B depicts an exemplary screenshot showing the functionality of a bank component of a system in vendor mode, in which a bank can review and accept requests by vendors for loans offered at a favorable interest rate.

FIG. 5C depicts an exemplary screenshot showing the functionality of a bank component of a system in vendor mode, in which a bank can review information about outstanding loans.

FIG. 5D depicts an exemplary screenshot showing the functionality of a bank component of a system in redeem points mode, in which a bank can redeem points with a system transaction facilitator for cash.

FIG. 6A depicts an exemplary screenshot showing the functionality of a facilitator component of a system in consumer mode, in which a system transaction facilitator can set the rate at which consumers receive system currency in exchange for performing certain transactions.

FIG. 6B depicts an exemplary screenshot showing the functionality of a facilitator component of a system in vendor mode, in which a system transaction facilitator can set the redemption rate of system currency for vendors, and can set the commission rate for sales of goods and/or services by vendors to consumers.

FIG. 6C depicts an exemplary screenshot showing the functionality of a facilitator component of a system in bank mode, in which a system transaction facilitator can set the redemption rate of system currency for banks, and can set the commission rate for loan payments made to banks from loans initiated through the use of the system.

FIG. 7 depicts an exemplary screenshot showing a system currency trading system for use by a consumer, a vendor or a bank through a consumer component, a vendor component or a banking component, respectively, in which such parties may view offerings for sales of system currency, may elect to purchase the system currency indicated in such offerings, and may create an offering to sell system currency.

Reference will now be made to the drawings, in which similar elements in different drawings bear the same reference numerals.

### DETAILED DESCRIPTION

Systems and methods for facilitating economic transactions between consumers, vendors and banks associated with the system utilizing a “system currency” will now be described. In general, the systems and methods disclosed herein create and administer a closed-end system whereby participating consumers, vendors and banks associated with the system can execute transactions between them using system currency alone or in combination with cash. The term “cash” as used herein refers to any standard national currency such as US Dollars, Canadian Dollars or any other national currency. A “system transaction facilitator,” (or simply “facilitator”) facilitating the transactions described herein, is present. The system transaction facilitator may maintain accounts—one or more consumer special accounts, one or more vendor special accounts, and one or more banker special accounts—containing system currency and/or cash for consumers, vendors and banks, respectively, and may keep track of all transactions in the system and changes in cash and/or system currency balances in the special accounts. The vendor and consumer special accounts are preferably exclusive to the system, and the cash and system currency stored in the special accounts may only be used for transactions involving the system (e.g., the purchase of goods or services from vendors associated with the system). Penalties may apply if cash is withdrawn from the consumer special accounts or vendor special accounts.

In some embodiments, the system transaction facilitator is also a bank, while in other embodiments, the system transaction facilitator is not a bank. System currency may be used by consumers and vendors to obtain reduced cash prices on goods or services. System currency may also be used by vendors to obtain favorable interest rate loans from banks, and vendors may redeem system currency for cash at a pre-determined rate. In one preferred embodiment, system currency may be “created”, “destroyed” or maintained in a system treasury by the system transaction facilitator at will or at certain specified times, discussed below. In another preferred embodiment, system currency will never expire or be deleted and can be maintained in perpetuity. The system transaction facilitator may also set various system settings, including redemption rates for system currency, commission rates, and other settings as described below.

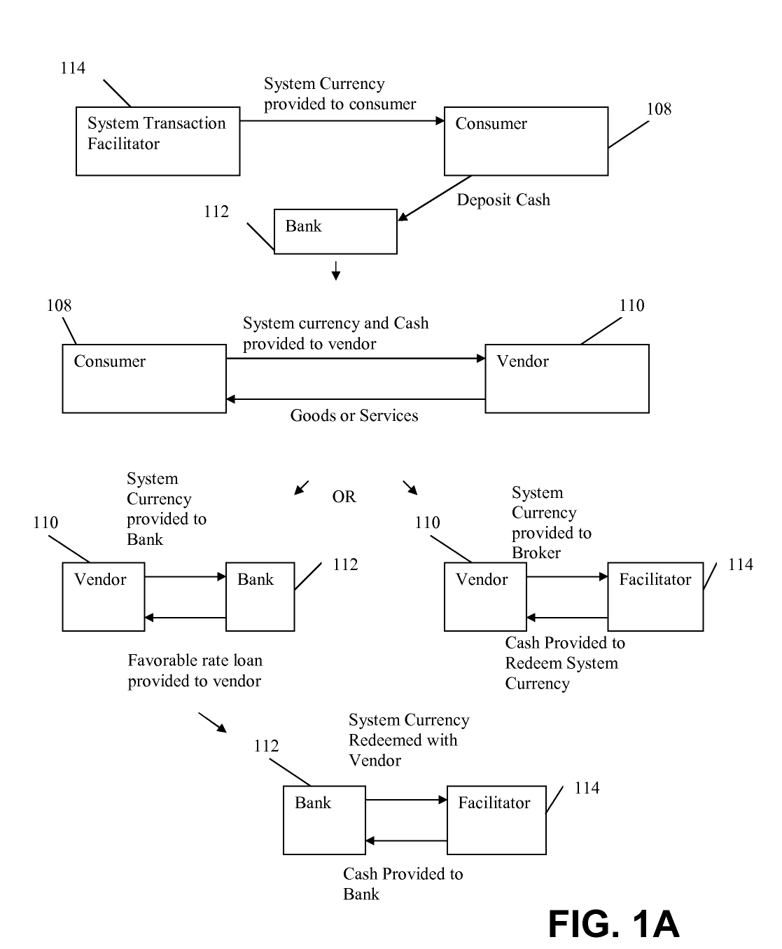

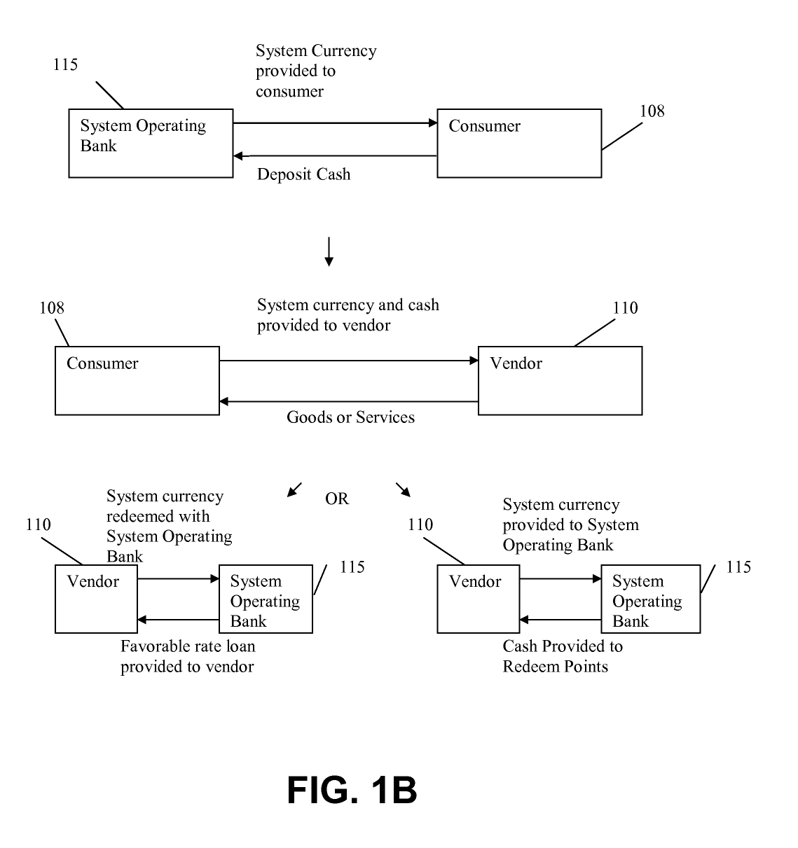

FIGS. 1A and 1B illustrate various commercial transactions among consumers, vendors and banks through use of the system, and depict “paths” through which system currency may travel. FIG. 1A depicts transactions in which the system transaction facilitator is a separate entity from the bank, while FIG. 1B depicts transactions in which the system transaction facilitator is the same entity as the bank.

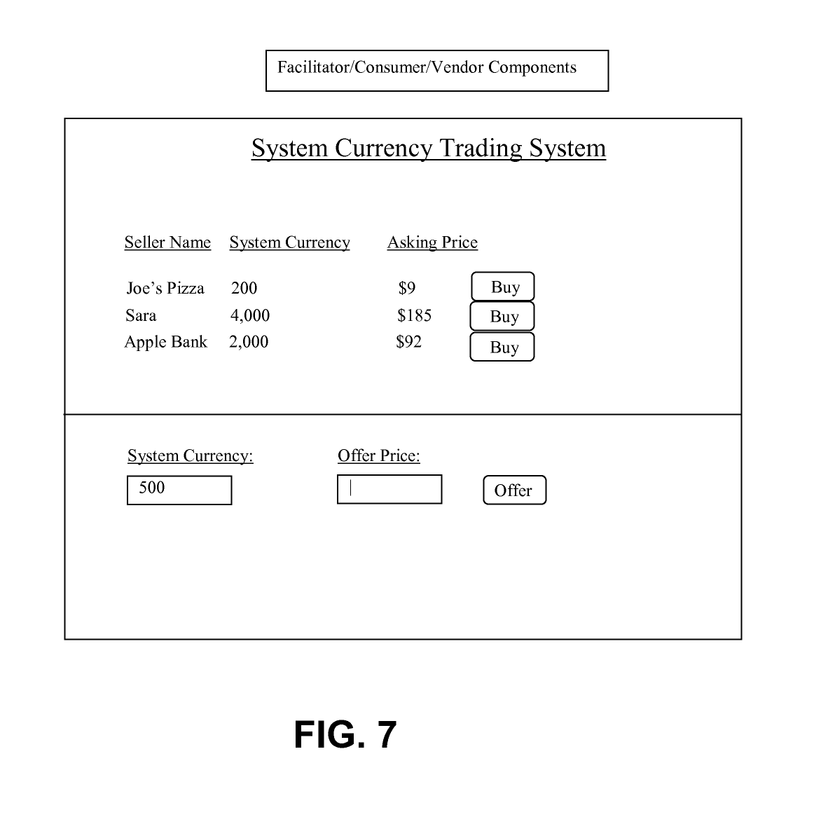

It should be understood that although these figures depict expected “paths” through which system currency is expected to travel, not all possible transactions are depicted in the figures. For example, parties may sell system currency using the system currency trading system (described later, with respect to FIG. 7).

It should also be understood that although the specification refers to actions conducted by “consumers,” “vendors” and “banks,” it is contemplated that in use, any party associated with the system may act in any role described herein. Thus, for example, consumers, may perform actions described herein as being performed by vendors, and banks may perform actions described herein as being performed by consumers. These examples should not be taken to be limiting, as it is contemplated any party associated with the system may perform any of the actions described herein.

In FIG. 1A, when a consumer 108 deposits cash into a consumer special account at bank 112, the system transaction facilitator 114 deposits system currency in the consumer's special account. The system transaction facilitator 114 may provide an amount of system currency equivalent to a fixed percentage of the amount of cash deposited into the consumer special account (for example, 20%). Alternatively, the system transaction facilitator 114 may provide a flat, fixed amount of system currency for an initial deposit amount meeting or exceeding a certain minimum required amount.

The system transaction facilitator 114 may subsequently provide system currency periodically, for example yearly, in lieu of or in addition to monetary interest payments on the amount of cash the consumer has deposited into his special account. For example, a consumer who maintains $1,000 in a consumer special account may receive 200 units of system currency every year. The system transaction facilitator 114 may charge a penalty in system currency or in cash upon early withdrawal of the cash deposited, or may require that the cash be deposited for a certain amount of time before system currency is awarded to a consumer. This helps to prevent consumers from depositing cash to obtain system currency, using the system currency to obtain a reduced cash price from a vendor, and withdrawing the cash such that the vendor or bank never benefits from the deposit.

Any participating member of the system may use system currency to purchase goods or services at a reduced cash price. For example, the consumer 108 may utilize system currency to purchase goods or services from a vendor 110 at a reduced cash price. A good or service may have both a full price and a reduced cash price which is less than the full price. To be able to purchase the good or service at the reduced cash price, the consumer must spend system currency in addition to or in lieu of cash. The amount of system currency required for a specific reduced cash price depends on a variety of factors, including the full price of the good or service, the amount of the reduction in cash required to make the purchase, and other factors. The term “services” may include, among other things, cash loans. Therefore, when this specification refers to a step or process of “obtaining” “services”, that step or process may include the process of obtaining a cash loan, among other things.

When the consumer spends system currency to purchase a good or service at a reduced cash price, the system transfers system currency spent by the consumer's special account to the special account of the vendor from which the good or service is purchased, along with the cash required for the purchase, if any. It is possible for the reduction in cash price to be a full 100%, in which case only system currency is transferred from the consumer's special account to the vendor's special account, and no cash is transferred.

Sales of goods and services through this system may also be accompanied by commission provided to the system transaction facilitator 114 as compensation for providing and managing the system 100. The commission may be calculated as a percentage of the amount of cash used to make the purchase or a percentage of the amount of system currency used to make the purchase, or both. The commission may be paid in cash or system currency, or both.

The reduced cash price of the goods or services, and the amount of system currency required for the consumer to obtain the reduced cash price may be determined by the system transaction facilitator in accordance with the concepts and formulas set forth below. The term “payment ratio” may be used to refer to the ratio of a reduced cash price to a full cash price of goods or services. The term “cash reduction percent” is equivalent to the percentage by which the full price of a good or service is reduced to obtain the reduced cash price. For example, consumers may purchase a good or service with cash reduction percent of 5%, 25%, or 50% equivalent to payment ratios of 95%, 75% or 50%, respectively, or any other value.

The system may use a weighted scale to determine the amount of system currency required for a particular payment ratio or cash reduction. For example, a 5% cash reduction percent, equivalent to a 95% payment ratio may require an amount of system currency equal to 2.5% of the original price of the good or service, while a 30% cash reduction percent may require an amount of system currency equal to 90% of the original price. For example, for a good having a full price of $1,000, a 5% cash reduction percent (equal to a reduction of $50) would require an amount of system currency equal to 2.5% of 1,000, equal to 25 units of system currency. A 30% cash reduction percent for a good having a full price of $1,000, equivalent to a reduction of $300, would require an amount of system currency equal to 90% of the full price, equal to 900 units of system currency.

An exemplary weighted scale for determining the amount of system currency required for a particular cash reduction or payment ratio may use the following formula, which shall not be construed as limiting in any sense. Many other formulas and weighted scales may be used. First, multiply the cash reduction percent by the original price of goods or services to determine a base amount of system currency. Then, divide the cash reduction percentage by 10 to obtain a result. Multiply that result by the base amount of system currency to determine the amount of system currency required to obtain the reduced cash price.

This calculation will now be applied to exemplary numerical values. For a consumer to purchase a product costing $1,000 at a 50% cash reduction percentage (thus, a reduced cash price of $500), the amount of system currency required to obtain that cash reduction is calculated as follows. Multiply the cash reduction percentage (50%) by the original price ($1,000) to determine a base amount of system currency (50% of $1,000=500). Then divide the cash reduction percentage (50%) by 10 (50/10=5) to obtain a modified cash reduction percentage. Finally, multiply the modified cash reduction percentage (5) by the reduced cash price (500) to obtain the required amount of system currency to obtain the cash reduction (2,500 units of system currency). In another example, a consumer wants a cash reduction percentage of 5% off of an original cash price of $1,000. To determine the amount of system currency required for this cash reduction, multiply the cash reduction (5%) by the original cash price ($1,000) to determine a base amount of system currency (5% of $1,000=50). Then divide the cash reduction percentage (5%) by 10 (5/10=0.5) to obtain a modified cash reduction percentage. Finally, multiply the modified cash reduction percentage (0.5) by the reduced cash price (50) to obtain the required amount of system currency to obtain the cash reduction (25 units of system currency). Minimums and/or maximums may be utilized in this formula, such that, for example, the required amount of system currency does not fall below a minimum percentage (e.g., 5%) or exceed a maximum percentage (e.g., 5,000%).

The benefits of a weighted scale are as follows. First, a weighted scale better aligns the revenue reduction of the vendor with costs saved by the vendor. This is because fixed expenses such as advertising typically represent only a small portion of the cost of goods or services sold. In other words, the value of the benefits provided by the system—free advertising, a platform for sales, and the like—are comparable, roughly, to the value of the small cash price reduction provided. However, when a larger cash price reduction is provided, the benefits to the vendors of the system are no longer in line with the revenue reduction, so a greater amount of system currency is required to compensate the vendors for the revenue reduction. The weighted scale may be adjusted as desired by the facilitator to accommodate the cost structure of the goods or services offered.

Second, a weighted scale encourages consumers to make multiple purchases with small cash price reductions, rather than only a few purchases with large cash price reductions. This benefits vendors in that it drives an increase in sales, and helps to accomplish the overall goal of the system of driving increased economic activity.

Consumers 108 may also purchase reduced cash price goods and/or services from vendors 110 in an auction-style format. Different auction formats may be used, including an open price ascending auction, an open descending price auction, a sealed first-price auction, a sealed-bid second price auction, or other known types of auctions. Vendors 110 may choose to offer different goods in different auction formats or for sale in a normal, non-auction fashion. For example, a seller of clothes may offer commodities such as white socks in a non-auction fashion, and may offer one-of-a-kind or limited release goods for sale in an open price ascending auction format.

In auction format sales, bids may include a fixed amount of cash and variable amount of system currency, a fixed amount of system currency and a variable amount of cash, or a variable amount of both system currency and cash.

The vendor 110 may use system currency to buy goods or services from other participating vendors, or vendors may redeem the system currency obtained through sales with the system transaction facilitator 114 for a pre-specified amount of cash. For example, the vendor 110 may receive $0.05-$0.10 per unit of system currency redeemed. When redeemed, the system transaction facilitator 114 may destroy the system currency or maintain it in the treasury of the system transaction facilitator 114. The consumer 108 may also redeem system currency from the system transaction facilitator 114 in a similar manner.

The vendor 110 may also provide the system currency to a bank 112 in order to obtain a favorable interest rate loan. A favorable interest rate loan is a loan having an annual interest rate less than the market interest rate a bank would normally provide to the vendor requesting a similar loan. Optionally, the system may be configured such that the number of units of system currency required to obtain a favorable interest rate loan is equivalent to the number of units of currency for the loan amount. Thus, for example, if a vendor wishes to obtain a favorable interest rate loan in the amount of $10,000, the vendor may be required to provide 10,000 units of system currency to the bank. The number of units of system currency required may be affected by the credit rating of the vendor and if the credit rating is too low, then the vendor may not be given the option of obtaining a loan. However, the vendor may keep the system currency until its credit rating improves or exchange the system currency in its possession for cash.

After providing a favorable interest rate loan to a vendor 110, a bank 112 now has system currency received from the vendor 110. The bank 112 may redeem this system currency with the system transaction facilitator 114 for cash at a fixed rate. This allows the bank 112 to be compensated for the interest rate reduction provided to the vendor. The bank may also use the system currency to purchase goods or services from participating vendors in the system.

FIG. 1B indicates a similar path as in FIG. 1A, except that a bank also has the role of the system transaction facilitator. Such a bank will be referred to herein as a “system operating bank” 115.

The path depicted in FIG. 1B is similar to that in 1A except that the system operating bank 115 does not redeem system currency obtained from providing favorable interest rate loans to vendor 110, since the system operating bank performs the functions of both the bank and the system transaction facilitator. Additionally, because the bank also has the role of the system transaction facilitator, the system operating bank 115 obtains the commissions on sales made by vendors 110. Hence, the reduction in interest rate for favorable interest rate loans (i.e., the difference between a “market” interest rate for a loan and the favorable interest rate provided by the system operating bank 115) is at least partially compensated for by the intake of commission, unlike the path in FIG. 1A, in which the reduction in interest rate is partially compensated for by the redemption of system currency by the bank 112.

System currency may also be directly traded between parties associated with the system through the system transaction facilitator 114. This can be done with an auction style system or with a system permitting parties to offer to sell system currency at fixed prices. Thus a party, such as a consumer, may sell accumulated system currency to another party, such as another consumer or a vendor through the system transaction facilitator 114, and receive cash in return, subject to rules and conditions set by the system transaction facilitator 114. The system transaction facilitator 114 may also sell system currency to any other party associated with the system, including banks 112, vendors 110 or consumers 108, at a price determined by free market principles or fixed by the system transaction facilitator 114.

It should be understood that for any transaction, any party associated with the system may act as either a vendor or a consumer. Thus, for example, a party which sells a large number of goods or services utilizing the system and thus usually “acts” as a vendor may participate in transactions in which that party is a consumer. That party may purchase goods or services from other parties who use the system, and may use system currency to purchase those goods or services at a reduced cash price. Similarly, a party which typically purchases a large number of goods or services utilizing the system and thus usually “acts” as a consumer may participate in transactions in which that party is a vendor. That party may sell goods or services to other parties who use the system, and may accept system currency in exchange for giving a reduced cash price.

It should also be understood that it is intended for system currency to be freely transferrable between parties who utilize the system. Thus, for example, employers may provide system currency to their employees as employee compensation. Companies may also offer system currency as a dividend to parties who hold stock in that company. Governments may also offer system currency to individuals or companies as, for example, government subsidies, social security bonuses, or other payments. Additionally, vendors may offer rewards to repeat consumers in the form of system currency for repeat purchases or for meeting other purchase or consumer-based criteria. For example, a consumer who spends over $1,000 to purchase goods or services from a vendor may receive a reward of 50 units of system currency for their loyalty to that vendor. Other ways to transfer the system currency may of course be used.

In an alternative version of the system, the bank may be a consumer-owned bank. This consumer-owned bank will have the same functionality as bank 112. However, a consumer owned bank is a bank which, instead of being owned by a third party, is owned by one or more of the consumers who utilize the system. Partial ownership is granted to consumers upon depositing cash into a bank account. Additional ownership stakes may also be sold to consumers at a later time for cash or for system currency. The amount of partial ownership granted to customers, and the cost of additional purchases of partial ownership stakes may be varied as desired.

Consumer ownership of the bank further aligns the interests of all the parties which use the system. With consumer ownership of the bank, only two kinds of parties participate in the system: consumers and vendors. Consumers and vendors thus gain a sort of “partnership” in which consumers loan cash to vendors and are able to purchase goods or services at reduced cash prices.

The transactions described above may be implemented in a variety of ways. One way to implement these transactions is through the use of a distributed computer system having components for managing system currency and facilitating transactions using such system currency. This system will be referred to herein as a “transaction facilitation system.” The parties accessing this transaction facilitation system may include one or more vendors, one or more consumers, one or more banks, and one or more system transaction facilitators. Optionally, the bank and the system transaction facilitator may be the same party.

The transaction facilitation system preferably includes one or more standard physical computers, each comprising a central processing unit, a memory, an input/output device, and a bus. Data for the transaction facilitation system may be stored in a database stored on a non-volatile memory device. Memory may include instructions that, when executed by a CPU, provide the functionality described below. Memory may comprise any of a wide variety of known types of data storage systems, including magnetic media, optical media, random access memory or read only memory, or other known types of memory. It should be understood that the method steps discussed below are to be performed by a CPU executing computer instructions stored in memory.

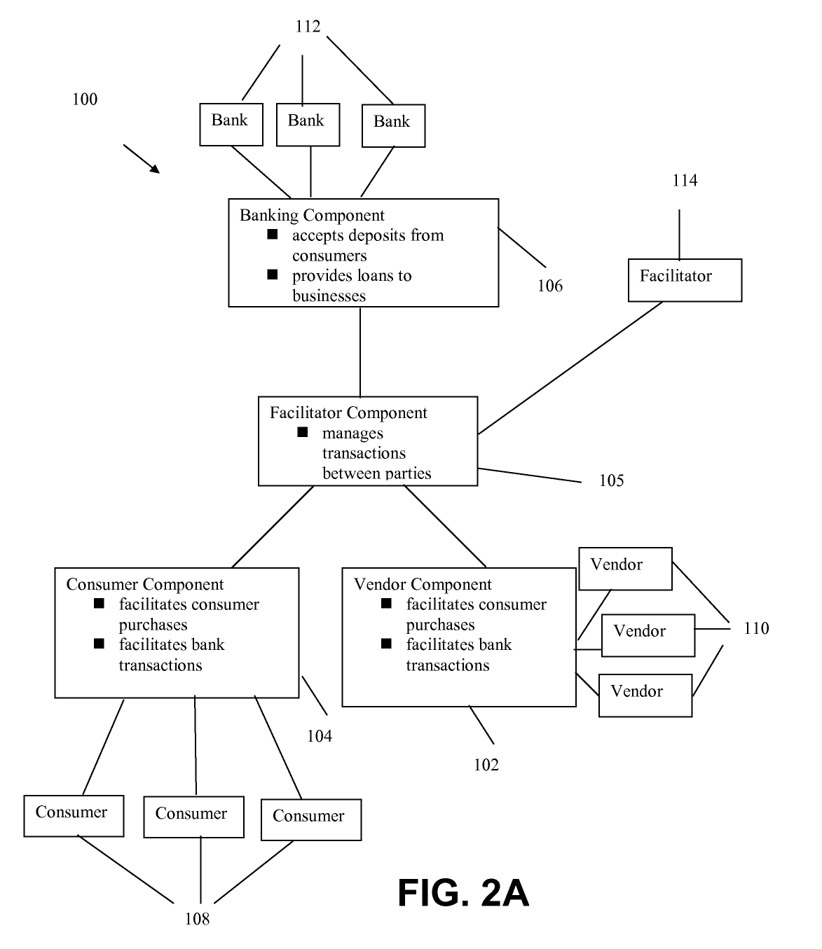

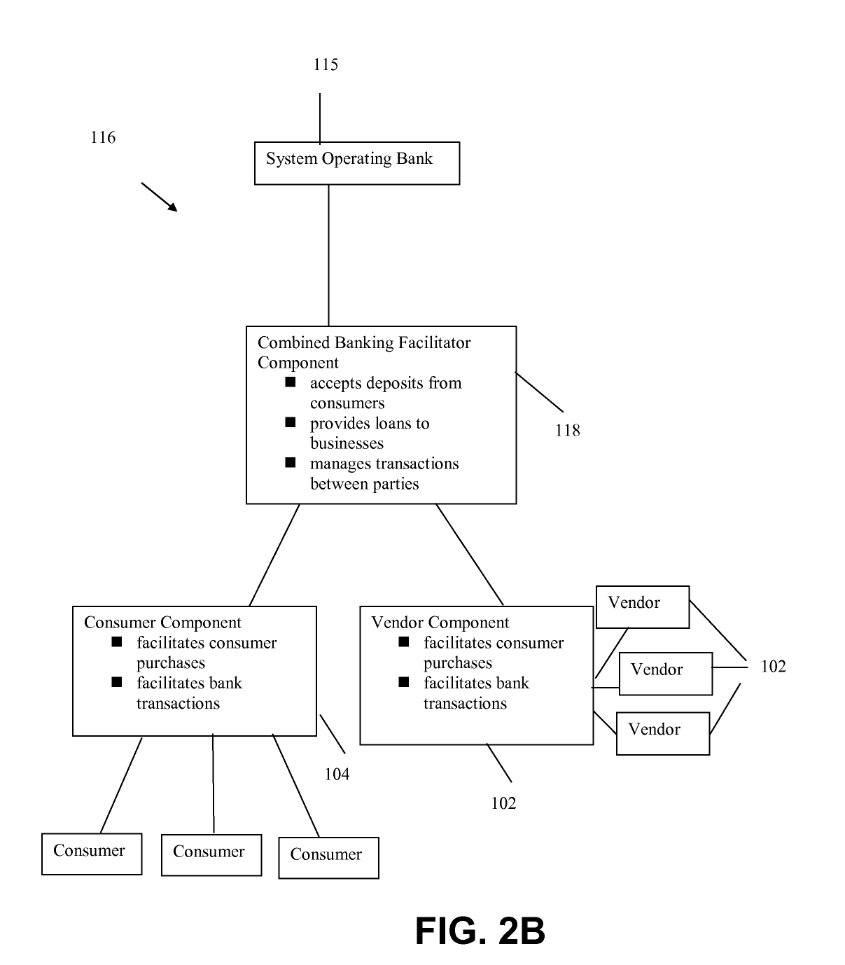

A first embodiment of a transaction facilitation system 100 is depicted in FIG. 2A. The transaction facilitation system 100 has multiple components, including a vendor component 102, a consumer component 104, a banking component 106 and a facilitator component 105, and interacts with a plurality of parties, including one or more consumers 108, one or more vendors 110 and one or more banks 112. A system transaction facilitator 114 is also present for facilitating transactions between the parties and for managing the system.

In a second embodiment of the transaction facilitation system 116, depicted in FIG. 2B, consumer component 104 and vendor component 102 are all present, but facilitator component 105 and banking component 106 are replaced by a combined banking facilitator component 118 which performs all the functions of the facilitator component and the banking component. System operating bank 115 is a party that acts as both a system transaction facilitator and a bank, and communicates with the system through combined banking facilitator component 118.

Each component (vendor component 102, consumer component 104, banking component 106 and system facilitator component 105) is designed to interact with and provide system 100 functionality primarily to a single type of party. Thus, all components—vendor component 102, consumer component 104, banking component 106 and system facilitator component 105—may be embodied as software or hardware at any physical location which permits the intended party to operate the associated component. Each of the components may be a computer program installed on standard or specialized computer hardware located at a component user's place of business, a dedicated hardware device, a combination of dedicated software and hardware, an Internet website, network based software, or any other such computer program or device that provides the appropriate functionality to the intended party. For an Internet-based component, the component user may log in to a website which hosts the component, which is in turn connected to the rest of the system. System facilitator component 105 may perform some of the functions of the system transaction facilitator 114, such as creation, deletion and storage of system currency, and moving system currency between different accounts, automatically.

All components may be connected to each other through any means known in the art, such as over the Internet, over a local network, or through other known interconnection protocols.

Functionality of the vendor component 102, consumer component 104, banking component 106, and facilitator component 105 will now be described in detail. Because these components may be implemented as computer programs running on computer devices, these descriptions will make reference to example computer interface screens which provide some of the functionality described. It should be understood, however, that the screenshots provided are simply exemplary and illustrative of the concepts disclosed herein, and should not be taken to be limiting.

Consumer component 104 allows consumers to view offers from vendors for sale of goods and services. Information about such goods and services may be transferred to the consumer component from the vendor component and may be used to update a database of information local to the consumer component. When such information is updated, the consumer component may notify consumers of certain goods or services by, for example, e-mail. The consumer component 104 may notify consumers each time the information is updated, periodically (e.g., every Monday), when a “threshold” number of offers for sale of goods and services have been updated, or at any other time deemed appropriate.

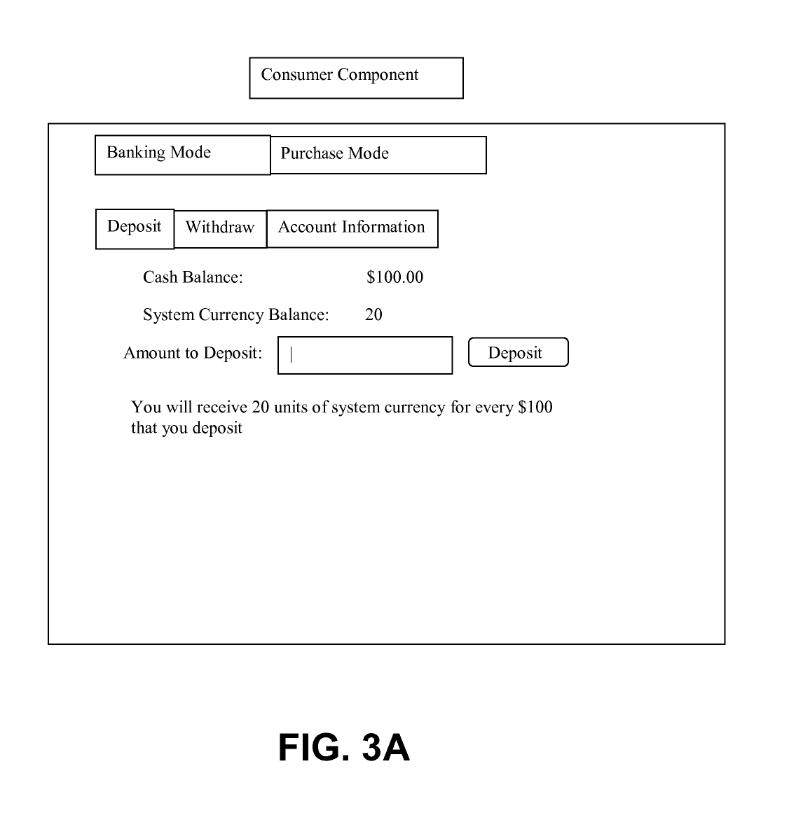

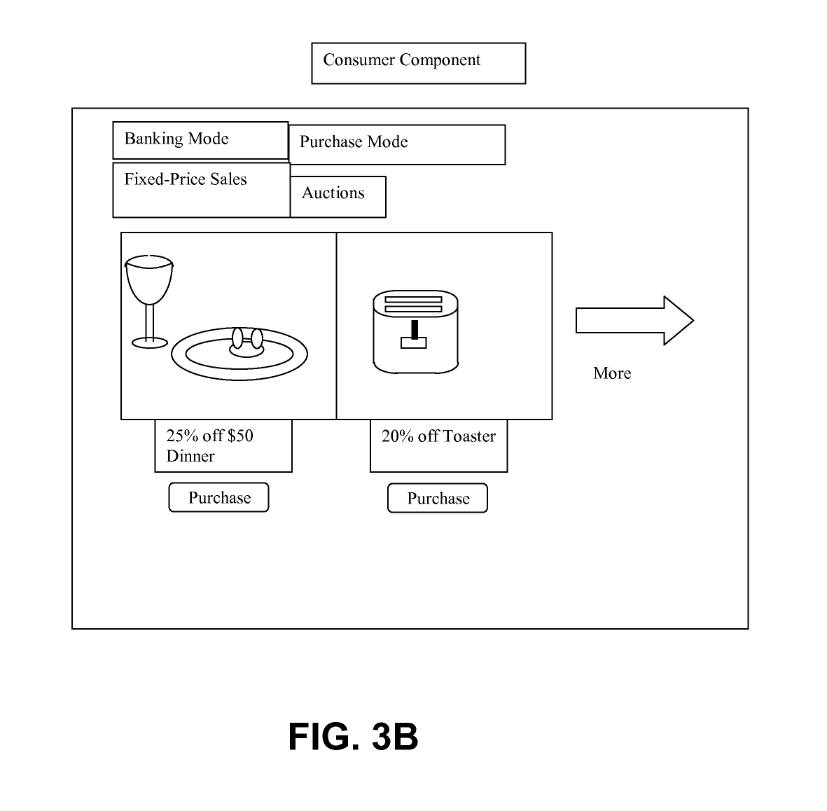

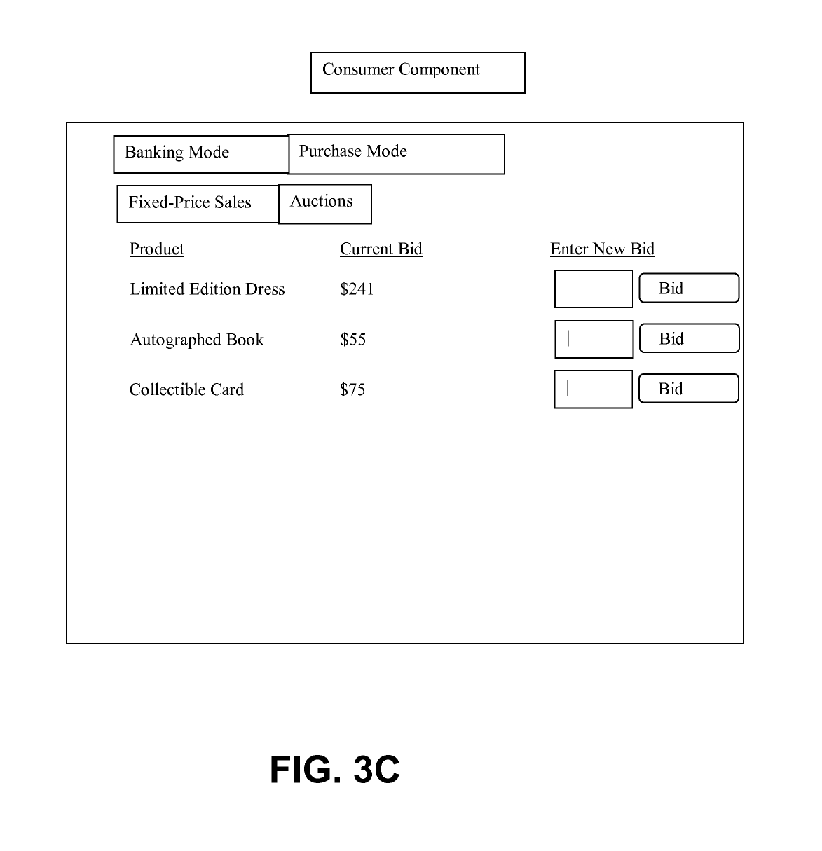

Consumers may interact with the consumer component 104 in one of two modes: banking mode, and purchase mode. In banking mode, a consumer may interact with one or more consumer special accounts managed by the system and may manage system currency maintained in the consumer special accounts. In purchase mode, a consumer may interact with one or more vendors to utilize system currency to purchase goods or services at reduced cash prices. When using the consumer component interface, depicted in FIGS. 3A and 3B, consumer may select banking mode or purchase mode through corresponding buttons as shown.

In banking mode, the consumer can make cash deposits and receive system currency, which will both be maintained in the consumer special account within the transaction facilitation system 100. The consumer special account may be set up to receive deposits of cash in many ways known in the art including, for example, electronic transfers of cash amounts from accounts maintained by the consumer at other banks.

FIG. 3A depicts an example screen for banking mode. In banking mode, consumer may select deposit, withdraw, or account information through the corresponding buttons. Consumer may also view their cash balance, system currency balance, and deposit rate which represents the amount of system currency the consumer will get upon depositing a certain amount of cash. Consumer may also enter an amount of cash to deposit in order to obtain system currency.

In purchase mode, depicted in FIGS. 3B and 3C, the consumer can request information about current reduced cash prices for goods and/or services offered by a participating vendor. The information about goods and/or services may include information such as which products are offered, what their full prices are, what their reduced cash prices are, how much system currency is required, the availability of such products, and so on. For fixed price goods, as depicted in FIG. 3B, when a consumer wishes to make a purchase, the consumer notes the price of a desired good or service and of the required amount of system currency for the good or service, and indicates the desire to make that purchase. This purchase request may be verified with the relevant vendor, and payment in the form of cash and system currency may then be accepted from the consumer. For auctioned goods or services, as depicted in FIG. 3C, the consumer may bid on items. If the consumer's bid wins the item, the consumer is able to purchase the item.

The consumer component 104 may allow or require users to register with the service in order to retain user information such as contact information, billing information, shipping addresses, user shopping preferences, and other information. The consumer component may notify registered users about “featured” goods or services in order to gain users' interest so that they may browse for additional goods or services to purchase.

The vendor component 102 provides system 100 functionality primarily for vendors 110. Vendors 110 may interact with the vendor component 102 in one of three general modes: price setup mode, sales mode, and banking mode. In price setup mode, a vendor 110 selects one or more goods or services for offer at a reduced cash price. In sales mode, the vendor 110 may make and/or verify sales of goods or services. In banking mode, a vendor 110 may utilize accumulated system currency to obtain loans at a favorable interest rate or may redeem system currency for cash.

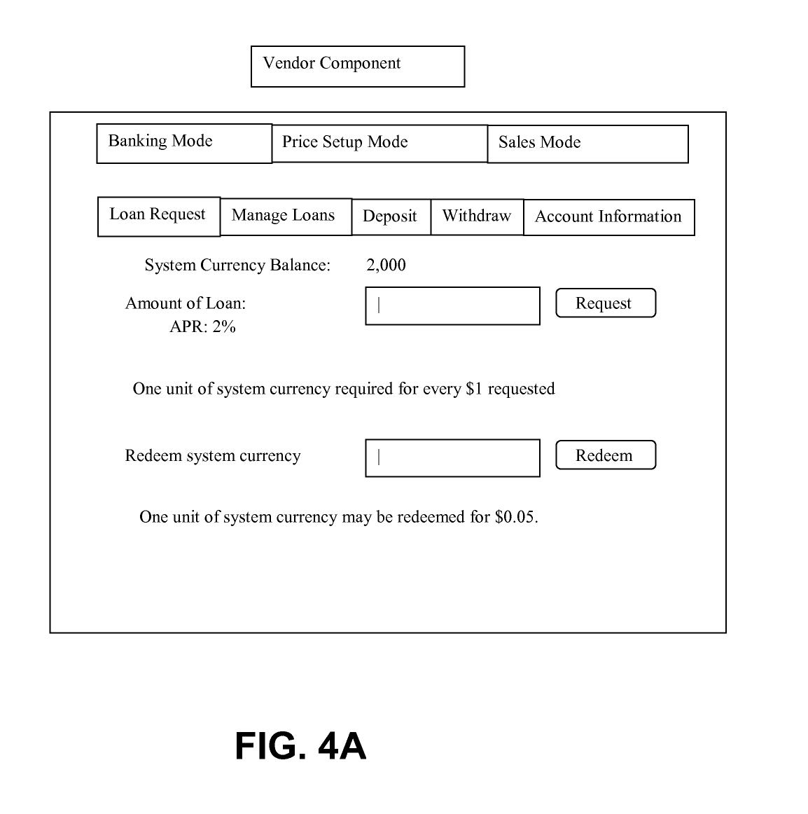

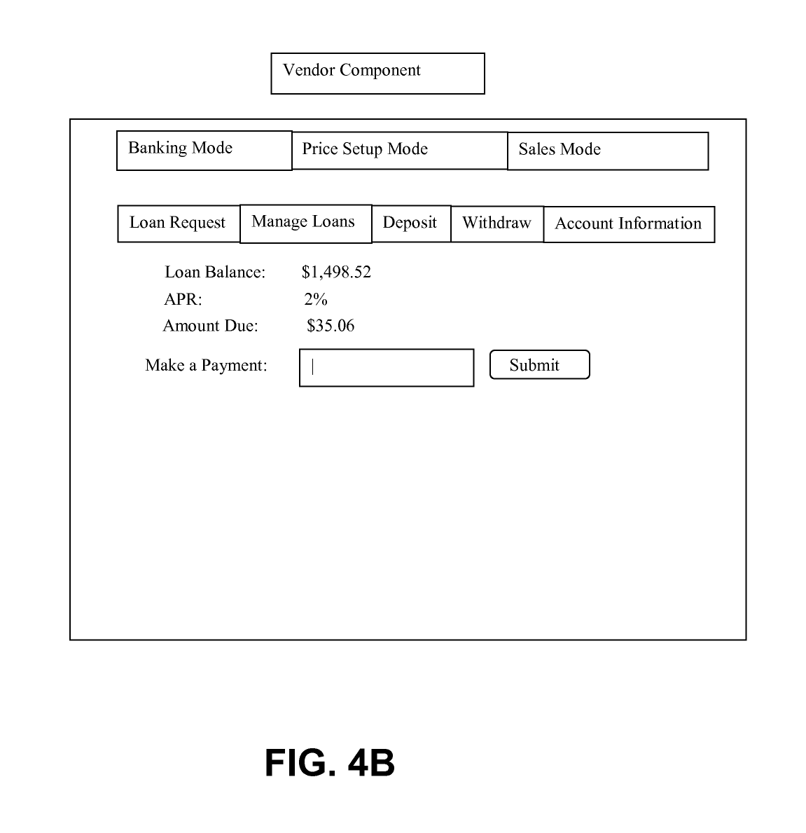

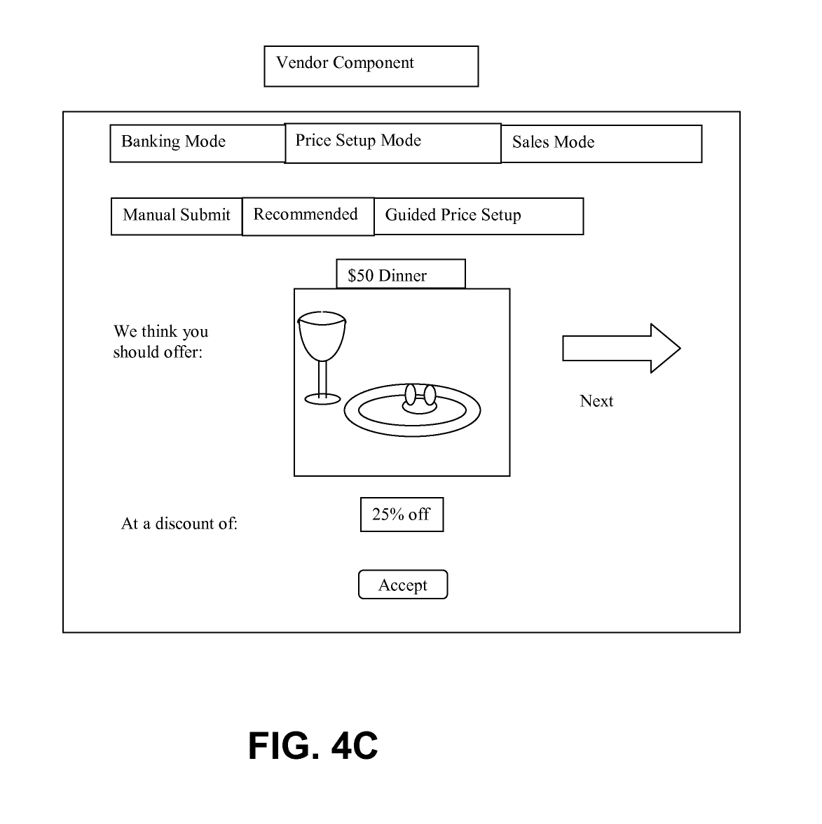

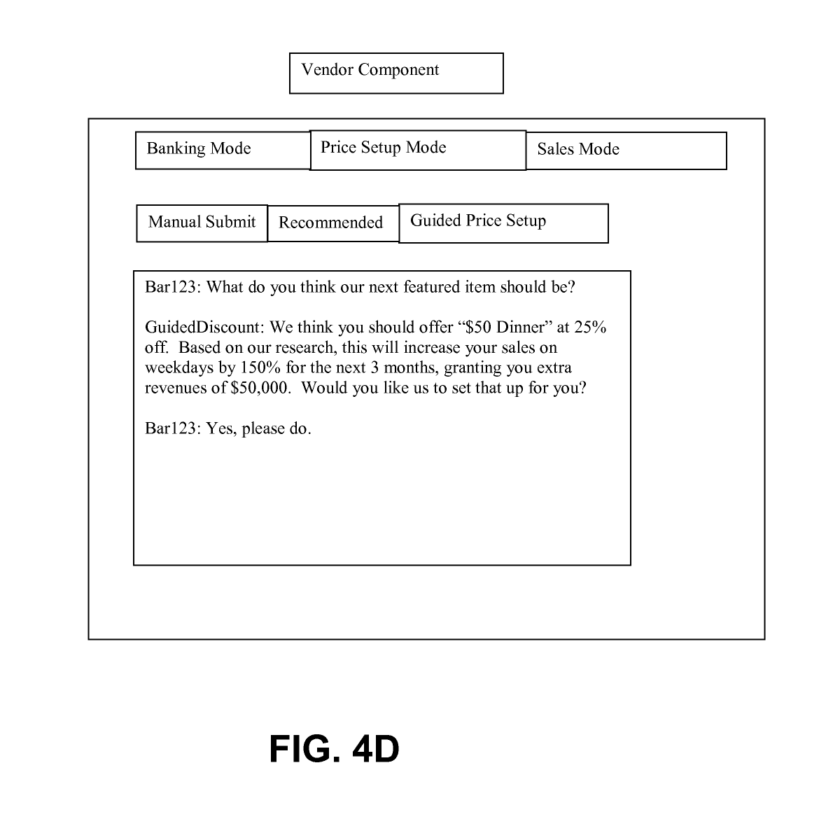

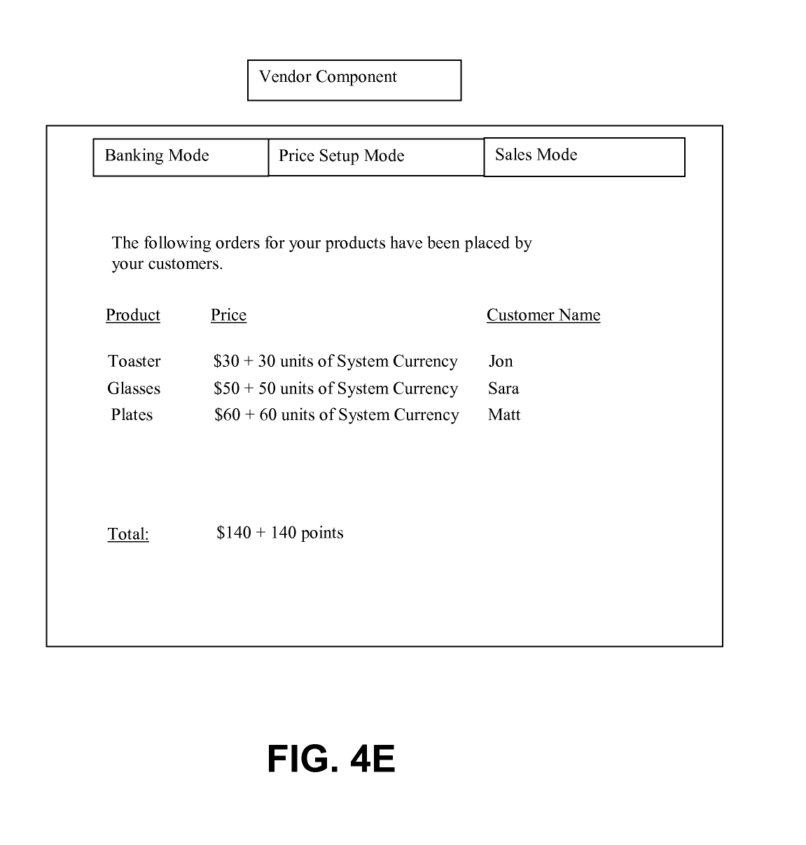

FIGS. 4A and 4B depict example screens for a banking mode. In FIG. 4A, the vendor 110 may submit a request for a loan having a favorable interest rate. The bank may provide a list of favorable interest rate loans and the required number of units of system currency needed per unit of currency for each loan. If the vendor 110 wishes to obtain such a loan and has the required amount of system currency, the vendor 110 indicates this. The vendor 110 may also redeem system currency for cash. In FIG. 4B, the vendor 110 may manage outstanding loans the vendor 108 has. The vendor may view outstanding loans, loan balances, amount currently due, current interest rate, and may make a payment on an outstanding loan. Optionally, the facilitator may take a commission on each loan payment made by vendors.

In price setup mode, a vendor 110 registers information about goods or services for sale with the transaction facilitation system 100. Vendors 110 may select goods or services to offer for sale at reduced cash prices, and communicate with the system transaction facilitator 114 to set up reduced cash prices for goods or services. System transaction facilitator 114 may determine products for which such reduced cash prices would be beneficial to the vendor 110, and will determine a specific reduced cash price for each product or service offered based on the concepts and formulas set forth above. By virtue of the fact that the system transaction facilitator 114 processes product sales transactions for a large number of consumers, the system transaction facilitator 114 may possess important and valuable market information enabling vendors 110 to offer reduced cash prices, which are effective at driving further purchases.

In FIGS. 4C-4D, two example methods of selecting reduced cash prices are shown. First, as shown in FIG. 4C, the vendor 110 may choose from among a list of recommended goods or services for offer at reduced cash prices. Third, as shown in FIG. 4D, the vendor 110 may communicate with system transaction facilitator 114 through, for example, online chat, to determine a desired good or service and reduced cash price. The vendor 110 may receive important information regarding such a reduced cash price.

In sales mode, a vendor accepts purchase requests from a consumer and accepts payment in the form of cash combined with any required system currency. The vendor may then ship goods or provide services or a voucher for services to the consumer who made the purchase.

In FIG. 4E, an exemplary sales mode screenshot is shown in which the vendor 110 may review purchase requests from consumers 108. This screen may show the total amount of cash and system currency obtained from the sales of vendor's 110 goods or services.

A third component is a banking component 106. This allows banks to provide financial services to consumers and vendors through the system 100.

Banks may interact with the system in one of two general modes: consumer mode, and vendor mode. In consumer mode, the financial institution may review consumer deposits made through the use of the system. In vendor mode, the financial institution initiates loans with vendors at a favorable interest rate and accepts system currency.

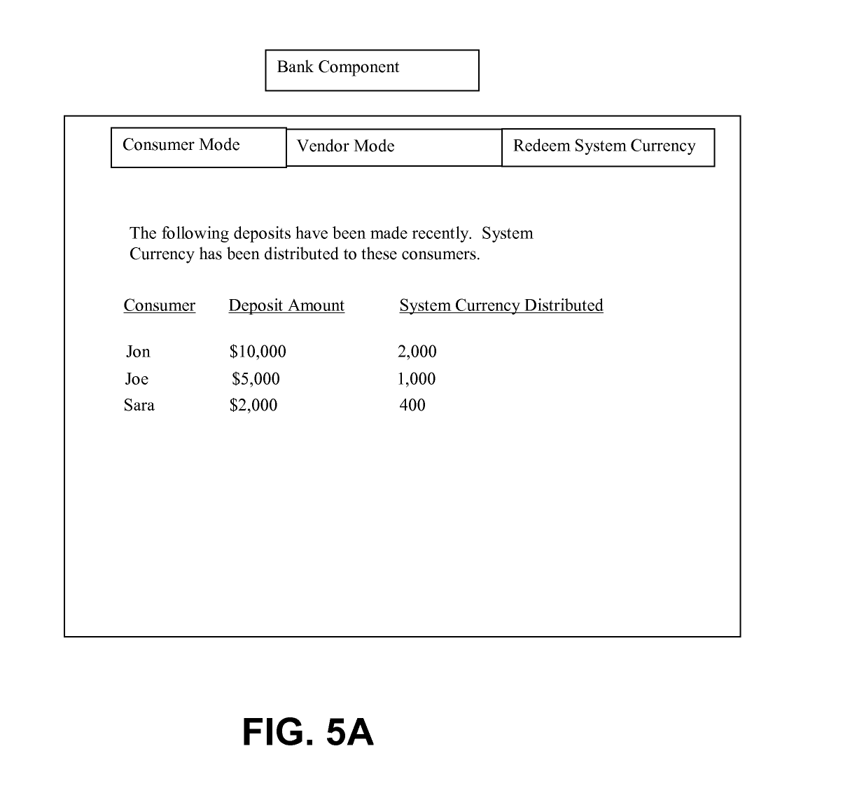

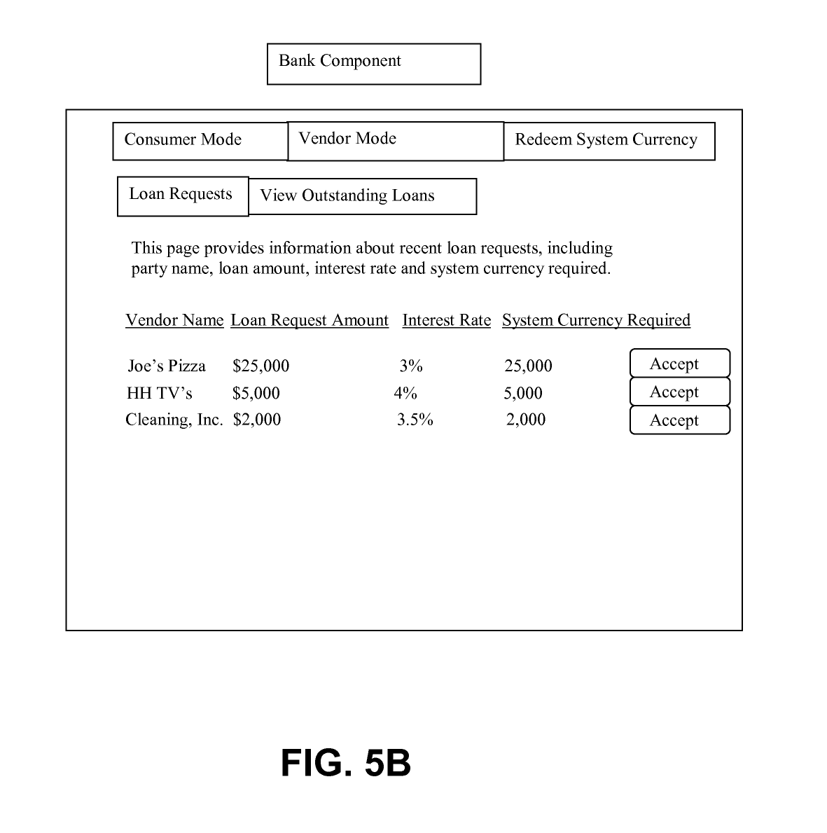

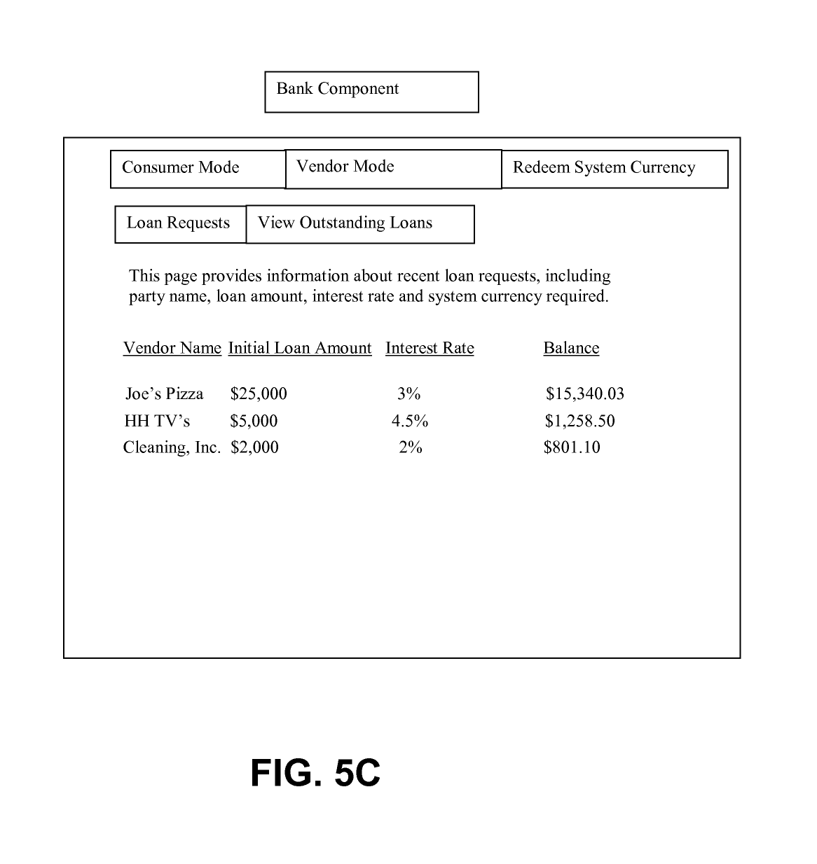

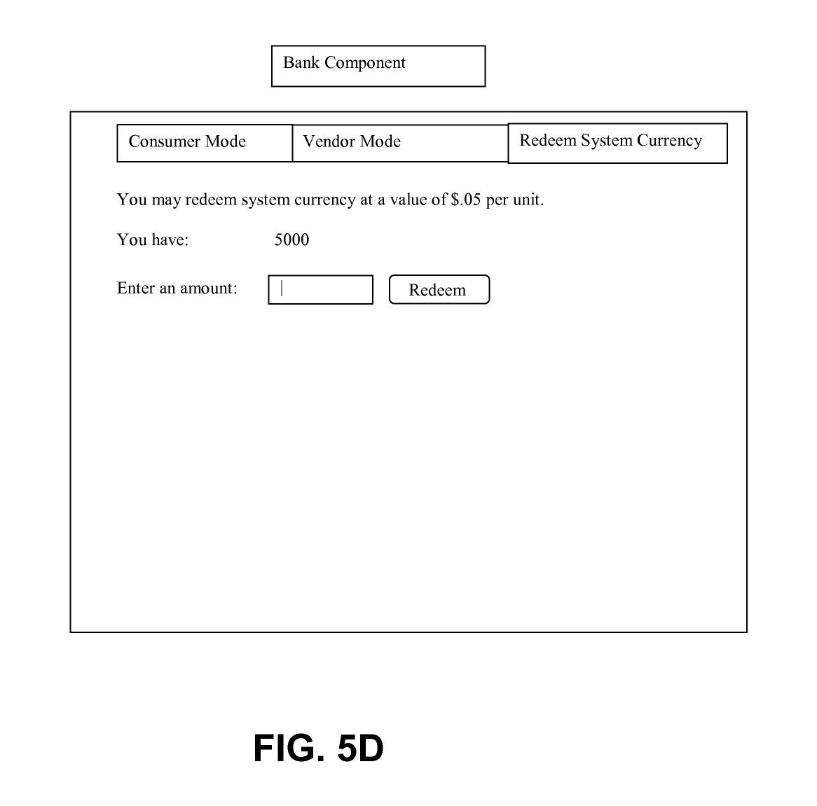

FIGS. 5A-5D show example screens for different functions of the banking component. FIG. 5A shows a screen in which the bank may view various deposits may by consumers and distributions of system currency to consumers. FIG. 5B shows a screen in which the bank may view loan requests from different vendors and may choose to accept each of those loans. FIG. 5C shows a screen in which the bank may view details about outstanding loans, including the vendor who took out the loan, the initial loan amount, the interest rate, and the current balance. Other information may also be provided. FIG. 5D shows a screen in which the bank may redeem system currency with the system transaction facilitator for cash. This is, of course, if the bank and system transaction facilitator are not the same entity. The screen shows the current balance of system currency and the redemption rate.

A fourth component, the transaction facilitator component 105, facilitates the various transactions described above. The transaction facilitator component 105 may also permit a system transaction facilitator 114 to change various system settings.

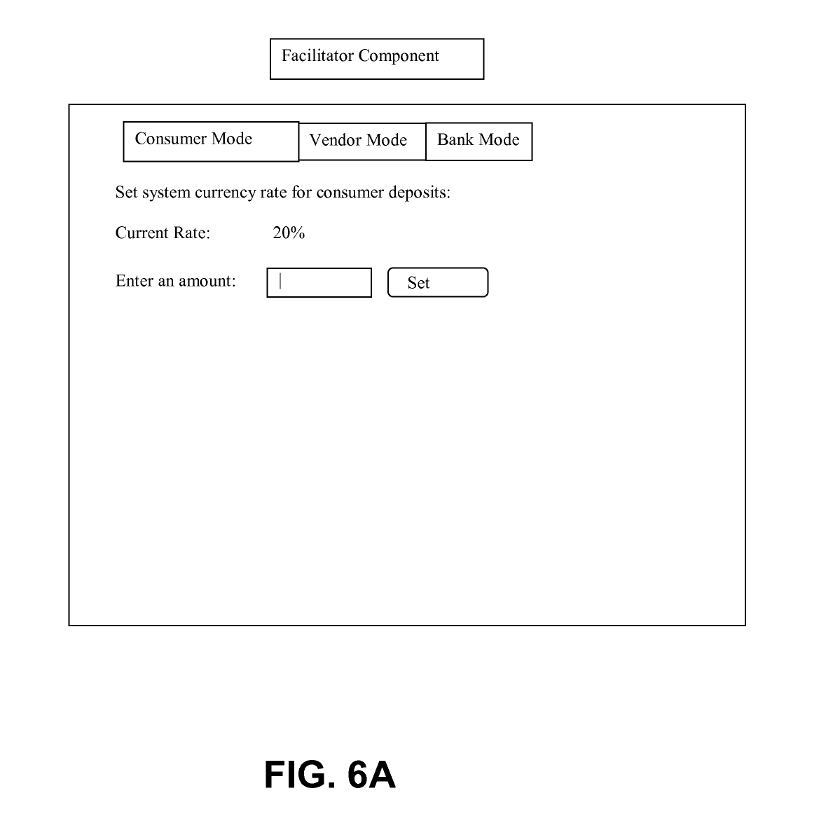

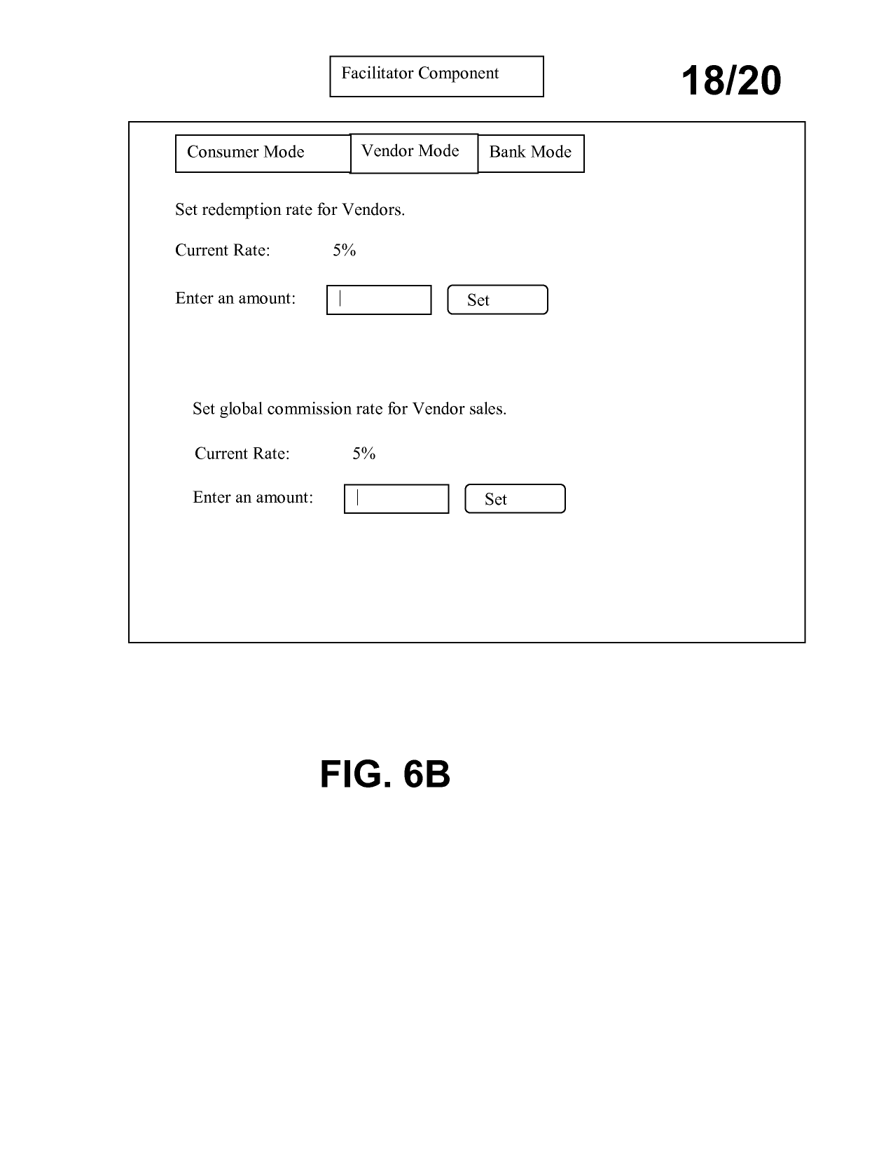

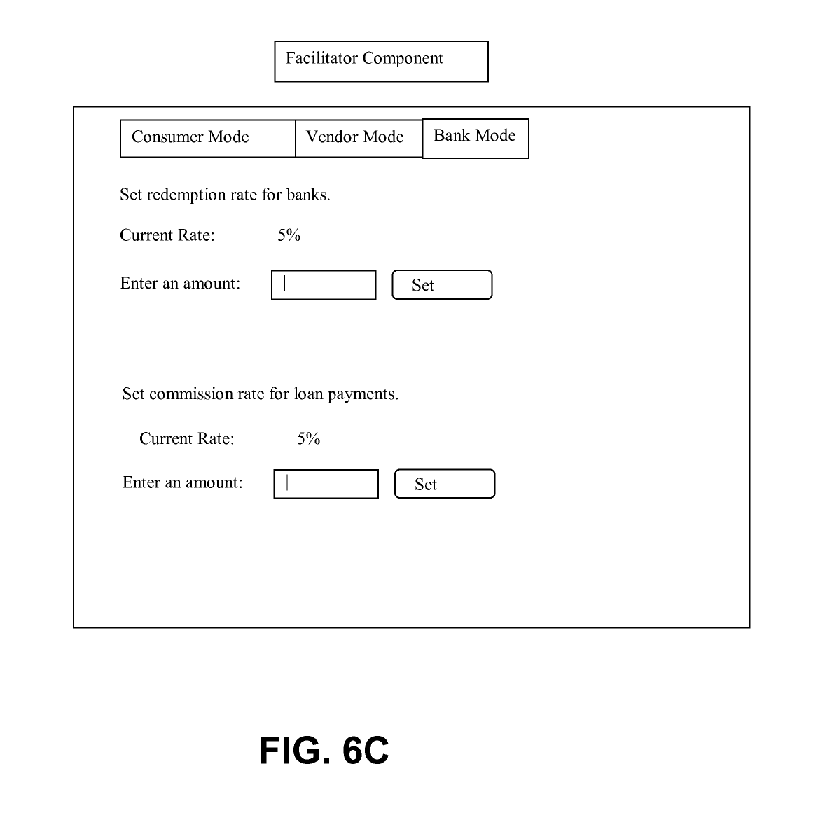

FIGS. 6A-6C show several exemplary screens depicting functionality for the transaction facilitator component 105. In FIG. 6A, in consumer mode, the system transaction facilitator 114 may set a rate at which consumers will be granted system currency for depositing cash in a bank. In FIG. 6B, in vendor mode, the system transaction facilitator 114 may set the vendor system currency redemption rate, which is the rate at which vendors may redeem system currency for cash (e.g., a 5% rate would provide $5 to a vendor for every 100 units of system currency redeemed) for vendors and may set the commission rate—the percentage of each sale which the system transaction facilitator may retain as a commission—for sales by vendors. In FIG. 6C, in bank mode, the system transaction facilitator may set the bank system currency redemption rate, which is the rate at which banks may redeem system currency for cash (e.g., a 5% rate would provide $5 to a bank for every 100 units of system currency redeemed) for banks. The system transaction facilitator may also set the commission rate for loan payments. This commission rate represents a percentage of each loan payment made by a vendor to a bank, which is provided as commission to the system transaction facilitator.

It should be understood that if the bank is the same entity as the transaction facilitator, the functions depicted in FIGS. 6A-6C and 5A-5D may be provided by the same component, a system operating bank component.

A system currency trading system is also provided, which allows buying and selling of system currency among the parties. An example screen for a system currency trading system is shown in FIG. 7. Consumer, vendors, and banks may browse current listings for system currency to purchase and may also submit a listing for sale of an amount of system currency. The system transaction facilitator may sell system currency to other parties utilizing the system.

### Incentives for Each Party Type

To ensure repeated use of the system by each type of party, the system should provide valuable benefits in the form of either monetary rewards, or intangible benefits such as advertising, brand recognition or the like, to each party. The principal benefit for consumers is increased buying power. Benefits for vendors include increased sales and revenues, the ability to obtain favorable interest rate loans, and direct monetary benefits. Benefits for banks and system transaction facilitators include increased transaction commissions and increased loan interest payments. Presented below are detailed descriptions of various types of benefits provided by the system.

### Consumers:

Consumers get the obvious benefit of having the ability to purchase goods or services at a reduced cash price. Thus the consumer has the ability to obtain more goods and services for the same amount of cash.

Consumers get a direct monetary benefit from the use of the system currency that they obtain in an amount equal to the reduction in cash required for their purchases. For example, if a consumer wishes to purchase goods or services normally priced at $100, but with a 25% cash price reduction obtained through the expenditure of 62.5 units of system currency, then there is a direct monetary benefit to the consumer equal to the amount of cash saved. In this example, that value is 25% of $100, which is $25. If a consumer is required to spend cash to obtain system currency, then the amount of cash spent must be deducted from this benefit. For example, if a consumer purchases the system currency for 10 cents per unit of system currency, equivalent to $6.25, for 25 units, then that value must be subtracted from the benefit to the consumer. In the example provided, the total monetary benefit to the consumer would be $25−$6.25=$18.75. Expressed in abstract terms, the benefit to the consumer for each purchase is equivalent to:

Pₙ−P_{d}−(Pₛ*Pₚ)

Where Pₙ is the normal price of the good or service purchased, P_{d} is the reduced cash price, Pₛ is the number of units of system currency spent, and Pₚ is the price the consumer paid for each unit of system currency.

Preferably, the system will be designed to provide consumers with sufficient buying power to increase their spending past the amount they would spend without the use of the system. Further, one goal of the system is to increase economic activity by increasing consumer spending. Therefore, it is considered beneficial if the system drives an increase in consumer spending overall.

### Vendors:

Vendors also gain several types of benefits. First, the system may be beneficially used to service vendors with relatively little access to advertising resources. The system therefore provides the intangible benefit of driving additional consumers to the vendor (free advertising).

Further, the system may provide the benefit of increased net profits, if enough reduced cash price goods or services are sold. An abstract description of such additional net profits will now be provided.

Assume that without use of the system, a vendor normally sells S goods or services at a price of Pₛ. The vendor has expenses of Eₛ associated with the sale of each good or service. The vendor therefore has net profits of (Pₛ−Eₛ)×S. Assume that utilizing the system, which provides a reduced cash price of Pₛ−P_{d}, Sₑ additional goods or services are sold. Total net profits in this situation are (Pₛ−P_{d}−Eₛ)×(S+Sₑ). Determining what amount is needed to make a profit can be done by determining the difference in net profits between the situation where the goods or services are sold at full price and the situation where the goods or services are sold at a reduced cash price. If the difference is greater than zero, then the vendor has a net gain by offering the goods or services at a reduced cash price. Specifically, this difference is described as follows:

$$( {P}_{s} S + {P}_{s} {S}_{e} - {P}_{d} S - {P}_{d} {S}_{e} - {E}_{s} S - {E}_{s} {S}_{e} ) - ( {P}_{s} S - {E}_{s} S ) = {P}_{s} {S}_{e} - {P}_{d} {S}_{e} - {E}_{s} {S}_{e} - {P}_{d} S = ( {P}_{s} - {P}_{d} - {E}_{s} ) \times {S}_{e} - {P}_{d} S$$

Thus, if the extra net profits from the reduced cash price sales ((Pₛ−P_{d}−Eₛ)×Sₑ) is greater than the revenues lost due to the price drop (P_{d}S), then net profits are higher if the goods are offered to consumers at a reduced cash price.

The required number of reduced cash price sales Sₑ can be set such that an increase in net profit is assured. To break even, net profits from the reduced cash price sales should be equal to net profits from the full-priced sales:

(Pₛ−P_{d}−Eₛ)×(S+Sₑ)=(Pₛ−Eₛ)×S.

Equivalently, the total number of sales in this case (S+Sₑ) must be equal to (Pₛ−Eₛ)×S/(Pₛ−P_{d}−Eₛ), which is net profits from full-priced sales divided by profit per unit for reduced cash price sales:

(S+Sₑ)=(Pₛ−Eₛ)×S/(Pₛ−P_{d}−Eₛ)

On the other side, there are benefits that are provided to the vendor in the form of system currency. A certain number of units of system currency per sale are provided to the vendor, equal to Pₙ. System currency has an intrinsic value equal to Pᵥ per unit of system currency. This is the maximum value of the ability to sell the system currency or to use it for access to low interest rate loans. Adding the value of system currency to the equation gives:

(Pₛ−P_{d}−Eₛ+(PₙPᵥ))×(S+Sₑ)=(Pₛ−Eₛ)×S

(S+Sₑ)=((Pₛ−Eₛ)×S)/(Pₛ−P_{d}−Eₛ+(PₙPᵥ))

If the system transaction facilitator takes a commission from all vendors, equal to a value C for each unit sold, then total commission for all reduced cash price sales adds another term to the equation: C(S+Sₑ). Taking this into account changes the equation:

(Pₛ−P_{d}−Eₛ−C+(PₙPᵥ))×(S+Sₑ)=(Pₛ−Eₛ)×S

(S+Sₑ)=(Pₛ−Eₛ)×S/(Pₛ−P_{d}−Eₛ−C+(PₙPᵥ))

There are also benefits to the vendor in the form of intangible benefits such as advertising, or boost to reputation. The value of intangible benefits is equal to I. Adding the value of the intangible benefits to the equation gives:

(Pₛ−P_{d}−Eₛ−C+(PₙPᵥ))×(S+Sₑ)+I=(Pₛ−Eₛ)×S

(S+Sₑ)=((Pₛ−Eₛ)×S−I)/(Pₛ−P_{d}−Eₛ−C+(PₙPᵥ))

Expenses per unit may also be less for higher sales, because expenses comprise both fixed expenses (e.g., store clerks, rent, electricitiy, and the like) and variable expenses (e.g., the cost of materials). If total fixed expenses equals E_{f} and variable expenses equals Eᵥ per unit, then for full cash price sales numbers:

$${E}_{s} = ( {E}_{f} + {E}_{v} S ) / S = {E}_{f} / S + {E}_{v}$$

For reduced cash price sales numbers, expenses per unit (Eₛₑ) is equal to:

$${E}_{se} = ( {E}_{f} + {E}_{v} ( S + {S}_{e} ) ) / ( S + {S}_{e} ) = {E}_{f} / ( S + {S}_{e} ) + {E}_{v}$$

It can be seen that expenses per unit for the reduced cash price sales numbers is smaller than the expenses per unit for the full cash price sales numbers. The total equation for the breakeven point now becomes:

(Pₛ−P_{d}−(Ed(S+Sₑ)+Eᵥ)−C+(PₙPᵥ))×(S+Sₑ)+I=(Pₛ−(E_{f}/S+Eᵥ))×S

This can be simplified to:

(Pₛ−P_{d}−Eᵥ−C+(PₙPᵥ))×(S+Sₑ)+I−E_{f}=(Pₛ−Eᵥ)×S−E_{f}

The fixed expenses terms cancel out, giving:

(Pₛ−P_{d}−EᵥC+(PₙPᵥ))×(S+Sₑ)+I=(Pₛ−Eᵥ)×S

Selling any number of items in excess of this breakeven point produces greater net profits for vendors.

### Banks:

The monetary benefit to using the system for banks come from two main sources:

First, banks normally utilize cash to provide loans to businesses. Because banks have a limited amount of cash, to benefit the banks, loans provided by banks must be made at the highest possible interest rate the banks could reasonably attain. One benefit of this system, however, is that by providing system currency to consumers who deposit cash with the associated bank, and thus incentivizing consumers to provide cash to the bank, the amount of cash available for lending is increased. If the banks provide favorable rate loans to businesses at annual interest rate with cash that would otherwise earn Lₑ interest, and the loans are made for a period of P years (where P may of course be a fractional value), then the gain for the banks is equivalent to:

P(Lᵢ−Lₑ).

If the bank is the same entity as the system transaction facilitator, i.e., the bank is a system operating bank, then the following benefits also apply.

System operating banks may take a commission on transactions such as sales of consumer goods or services processed using the system. In that case, if the number of transactions is T and the average commission per transaction is C, the gain for the banks is equal to T×C.

The system operating banks may be required to purchase system currency redeemed by vendors for a price equal to Pₚ. Assuming the number of redeemed units of system currency is equal to Pᵣ, the loss to the system operating banks in this situation is Pₚ×Pᵣ. However, this loss can be partially made up for by the commission the system operating banks take on each purchase. If vendors are provided with a number of units of system currency equal to Vₚ by performing transactions generating Cₚ in commissions for the banks, then the maximum loss to the banks for system currency redemptions is equivalent to Cₚ−(Vₚ×Pᵣ). Thus, the banks can assure profits on these transactions by setting the commission rate at a high enough level or the redemption rate at a low enough level.

Preferably, the redemption rate is set relatively low such that vendors are incentivized to use the system currency to take out loans, rather than redeem the system currency for cash. This can be done by ensuring that the monetary savings that the vendors would get by taking out the favorable interest rate loans is greater than the amount of cash vendors would get by simply redeeming the system currency. In this situation, both banks and vendors receive benefits because vendors get to lend cash out and earn interest while vendors get to save cash on their interest rate payments.

While the disclosure has been described with reference to various embodiments, it will be understood by those skilled in the art that various changes may be made and equivalents may be substituted for elements thereof without departing from the scope of the disclosure. In addition, many modifications may be made to adapt a particular situation to the teachings of the disclosure without departing from the essential scope thereof. Therefore it is intended that the disclosure not be limited to the particular embodiment disclosed herein contemplated for carrying out the methods of this disclosure, but that the disclosure will include all embodiments falling within the scope of the appended claims.

I claim:

1. A system for facilitating commercial transactions comprising:
a facilitator component adapted to:
monitor a consumer special account associated with the system for storing system currency for a consumer, and a vendor special account associated with the system for storing system currency for a vendor; and
facilitate transactions utilizing system currency, the transactions being one or more of:
a first transaction in which the consumer deposits cash in the consumer special account and receives a first amount of system currency into the consumer special account;
a second transaction in which the consumer purchases goods and/or services at reduced cash prices from the vendor, and at least a portion of the system currency in the consumer special account is transferred to the vendor special account; and
a third transaction in which at least a portion of the system currency in the vendor special account is withdrawn from the vendor special account and used to obtain goods and/or services from another party associated with the system.

2. The system of claim 1, wherein:
the facilitator component is further adapted to monitor a banker special account for storing system currency for a bank; and
the third transaction is a transaction in which the portion of system currency withdrawn from the vendor special account is deposited into the banker special account and the bank provides a favorable interest rate loan to the vendor.

3. The system of claim 2, wherein:
the facilitator component is adapted to be operated by the bank.

4. The system of claim 1, wherein:
the facilitator component is further adapted to facilitate trading of system currency between the consumer, the vendor and the bank.

5. The system of claim 2, further comprising:
a consumer component having an interface for the consumer to conduct the first transaction and the second transaction;
a vendor component having an interface for the vendor to conduct the second transaction and the third transaction; and
a banking component having an interface for the bank to conduct the first transaction and the third transaction.

6. The system of claim 5, wherein each of the facilitator component, the vendor component, the consumer component and the banking component are embodied as a computer system having processing units executing instructions enabling the functionality of each respective component.

7. The system of claim 5, wherein the vendor component is adapted to permit the vendor to designate reduced cash prices for goods or services offered by the vendor.

8. The system of claim 5, wherein the reduced cash prices may be decided at time of sale based on the request of the consumer and a weighted scale used to determine an amount of system currency required for the reduced cash prices.

9. The system of claim 1, wherein the facilitator component enables a system transaction facilitator to retain a commission on transactions facilitated by the system.

10. A method of facilitating commercial transactions comprising:
monitoring a consumer special account for storing system currency for a consumer, and a vendor special account for storing system currency for a vendor;
facilitating a first transaction in which the consumer deposits cash into the consumer special account and receives a first amount of system currency into the consumer special account;
facilitating a second transaction the consumer purchases goods and/or services at a reduced cash price from the vendor, and at least a portion of the system currency in the consumer special account is transferred to the vendor special account; and
facilitating a third transaction between the vendor and the bank in which at least a portion of the system currency in the vendor special account is withdrawn from the vendor special account and used to obtain goods and/or services from another party associated with the system.

11. The method of claim 10, further comprising:
monitoring a banker special account for storing system currency for a bank;
wherein the third transaction is a transaction in which the portion of system currency withdrawn from the vendor special account is deposited into the banker special account and the bank provides a favorable interest rate loan to the vendor.

12. The method of claim 11, further comprising facilitating a banker redemption transaction in which the bank redeems system currency from the banker special account for cash from a system transaction facilitator.

13. The method of claim 11, wherein the bank serves the functions of both a bank and a system transaction facilitator.

14. The method of claim 10, further comprising extracting a commission from each transaction facilitated by the system.

15. The method of claim 10, further comprising facilitating transactions for trading system currency between the consumer, the vendor and the bank.

16. The method of claim 10, further comprising notifying the consumer of featured sales of goods and/or services.

17. The method of claim 10, further comprising:
permitting sales of reduced cash price goods to be completed only if a minimum number of discounted goods or services are guaranteed to be sold, the minimum number being a number of reduced cash price goods or services that must be sold by a particular vendor for the vendor to realize a profit above what would have been realized had the reduced cash price good or service not been offered at a reduced cash price.

18. The method of claim 10, further comprising determining a favorable loan interest rate to be offered by bank and a commission rate taken by bank such that the commission rate permits the bank to at least break even with respect to reduction in revenue caused by providing loans at the favorable loan interest rate.

19. A system for facilitating commercial transactions comprising:
a facilitator component adapted to facilitate:
(a) deposit transactions in which a consumer deposits cash into a consumer special account associated with the system and receives a first amount of a system currency in the consumer special account; and
(b) purchase transactions in which the consumer purchases goods and/or services from a vendor associated with the system at a reduced cash price, and at least a portion of the system currency in the consumer special account is transferred to a vendor special account associated with the system.

20. The system of claim 19, wherein the facilitator component is further adapted to facilitate loan transactions between the vendor and a bank in which at least a portion of the system currency in the vendor special account is withdrawn in exchange for the vendor obtaining a loan from the bank at a favorable interest rate.
